(19) United States
(12) Patent Application Publication
(10) Pub. No.: US 2024/0212721 A1
(43) Pub. Date: Jun. 27, 2024

(54) MULTIMEDIA RESOURCE PLAYING METHOD AND RELATED APPARATUS

(71) Applicant: TENCENT TECHNOLOGY (SHENZHEN) COMPANY LIMITED, Shenzhen (CN)

(72) Inventor: Xiaoshuai CHEN, Shenzhen (CN)

(73) Assignee: TENCENT TECHNOLOGY (SHENZHEN) COMPANY LIMITED, Shenzhen (CN)

(21) Appl. No.: 18/596,234

(22) Filed: Mar. 5, 2024

Related U.S. Application Data
(63) Continuation of application No. PCT/CN2023/085834, filed on Apr. 3, 2023.

(30) Foreign Application Priority Data
Aug. 19, 2022 (CN) 202210998870.7

(51) Int. Cl. G11B 27/34; H04N 21/472

(52) U.S. Cl. CPC G11B 27/34; H04N 21/47217

(57) ABSTRACT

A multimedia resource playing method and apparatus including obtaining a playing request for a multimedia resource to be played, the playing request carrying an object identifier of a multimedia playing object and a multimedia identifier of the multimedia resource to be played, obtaining, based on the object identifier and the multimedia identifier, degrees of interest of the multimedia playing object in multimedia resource segments in different time intervals in the multimedia resource to be played, generating a playback progress bar based on the degrees of interest of the multimedia playing object, a sliding granularity of the playback progress bar matching a division granularity of each time interval, playing the multimedia resource to be played, and displaying the playback progress bar on a playing page of the multimedia resource to be played during the playing of the multimedia resource to be played.

### CROSS REFERENCE TO RELATED APPLICATIONS

This application is a continuation application of International Application No. PCT/CN2023/085834 filed on Apr. 3, 2023, which claims priority to Chinese Patent Application No. 202210998870.7, filed with the China National Intellectual Property Administration (CNIPA) on Aug. 19, 2022, the disclosures of each being incorporated by reference herein in their entireties.

### FIELD

The disclosure relates to the field of computer technologies, and in particular, to a multimedia resource playing technology.

### BACKGROUND

With the development of computer technologies, playing multimedia resources has become a common entertainment manner in daily lives of people. Usually, in a process of playing a multimedia resource, a playback progress bar of the multimedia resource can be displayed on a playing page of the multimedia resource. A user can adjust a playback progress of the multimedia resource by dragging a slider on the playback progress bar to change a location of the slider on the playback progress bar, which allows the user to choose to watch any multimedia resource segment in the multimedia resource.

However, dragging the slider on the playback progress bar can usually determine only a moment corresponding to when the multimedia resource is switched to the location of the slider. The user may need to repeat the drag operation a plurality of times to determine that a part of interest is played at the moment corresponding to the location of the slider. Therefore, the operation is not convenient and it is difficult to locate accurately at one time, leading to low efficiency and causing the user to unsuccessfully locate the specific content of interest, resulting in poor user experience.

### SUMMARY

Some embodiments provide a multimedia resource playing method, performed by a computer device, and including: obtaining a playing request for a multimedia resource to be played, the playing request carrying an object identifier of a multimedia playing object and a multimedia identifier of the multimedia resource to be played; obtaining, based on the object identifier and the multimedia identifier, degrees of interest of the multimedia playing object in multimedia resource segments in different time intervals in the multimedia resource to be played; generating a playback progress bar based on the degrees of interest of the multimedia playing object, a sliding granularity of the playback progress bar matching a division granularity of each time interval; and playing the multimedia resource to be played, and displaying the playback progress bar on a playing page of the multimedia resource to be played during the playing of the multimedia resource to be played, the playback progress bar indicating a playback progress of the multimedia resource to be played and the degrees of interest of the multimedia playing object.

Some embodiments provide a multimedia resource playing apparatus including: at least one memory configured to store program code; and at least one processor configured to read the program code and operate as instructed by the program code, the program code comprising: obtaining code configured to cause at least one of the at least one processor to obtain a playing request for a multimedia resource to be played, the playing request carrying an object identifier of a multimedia playing object and a multimedia identifier of the multimedia resource to be played, and obtain, based on the object identifier and the multimedia identifier, degrees of interest of the multimedia playing object in multimedia resource segments in different time intervals in the multimedia resource to be played; generation code configured to cause at least one of the at least one processor to generate a playback progress bar based on the degrees of interest of the multimedia playing object, a sliding granularity of the playback progress bar matching a division granularity of each time interval; playing code configured to cause at least one of the at least one processor to play the multimedia resource to be played; and display code configured to cause at least one of the at least one processor to display the playback progress bar on a playing page of the multimedia resource to be played during the playing of the multimedia resource to be played, the playback progress bar indicating a playback progress of the multimedia resource to be played and the degrees of interest of the multimedia playing object.

Some embodiments provide a non-transitory computer-readable storage medium storing computer code which, when executed by at least one processor, causes the at least one processor to at least: obtain a playing request for a multimedia resource to be played, the playing request carrying an object identifier of a multimedia playing object and a multimedia identifier of the multimedia resource to be played; obtain, based on the object identifier and the multimedia identifier, degrees of interest of the multimedia playing object in multimedia resource segments in different time intervals in the multimedia resource to be played; generate a playback progress bar based on the degrees of interest of the multimedia playing object, a sliding granularity of the playback progress bar matching a division granularity of each time interval; and play the multimedia resource to be played, and display the playback progress bar on a playing page of the multimedia resource to be played during the playing of the multimedia resource to be played, the playback progress bar indicating a playback progress of the multimedia resource to be played and the degrees of interest of the multimedia playing object.

It can be learned from the foregoing technical solutions that, after a multimedia playing object performs a play operation on a multimedia resource to be played, a playing request can be generated based on the play operation, so that a playing request for the multimedia resource to be played is obtained. The playing request carries an object identifier of the multimedia playing object and a multimedia identifier of the multimedia resource to be played. Therefore, degrees of interest of the multimedia playing object in multimedia resource segments in different time intervals in the multimedia resource to be played can be obtained based on the object identifier and the multimedia identifier. A playback progress bar is generated based on the degrees of interest of the multimedia playing object in the multimedia resource segments in the different time intervals in the multimedia resource to be played, the multimedia resource to be played is played, and the playback progress bar is displayed on a playing page of the multimedia resource to be played during the playing of the multimedia resource to be played. The playback progress bar is used for indicating a playback progress of the multimedia resource to be played and the degrees of interest of the multimedia playing object in the multimedia resource segments in the different time intervals in the multimedia resource to be played. Therefore, the multimedia playing object can learn of the degrees of interest in the multimedia resource segments in the different time intervals based on the playback progress bar, thereby quickly and intuitively finding a location of interest (that is, a time interval). A sliding granularity of the playback progress bar matches a division granularity of the time interval, so that the multimedia playing object can control the playback progress bar to reach the location of interest. In other words, in some embodiments, the location of interest can be intuitively found according to the playback progress bar, without repeating a drag operation a plurality of times. In this way, the location of interest can be quickly and accurately located, and the accuracy and efficiency of jumping to the location of interest can be improved, thereby improving user experience.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is an example diagram of a playback progress bar according to the related art.

FIG. 2 is a schematic diagram of a system architecture of a multimedia resource playing method according to some embodiments.

FIG. 3 is a flowchart of a multimedia resource playing method according to some embodiments.

FIG. 4 is an example diagram of a playing page of a multimedia resource to be played according to some embodiments.

FIG. 5 is a schematic structural diagram of an interest degree prediction model according to some embodiments.

FIG. 6 a schematic structural diagram of another interest degree prediction model according to some embodiments.

FIG. 7 is a schematic structural diagram of a description prediction model according to some embodiments.

FIG. 8 is a schematic diagram of an overall procedure of a multimedia resource playing method according to some embodiments.

FIG. 9 is a schematic architectural flowchart of a multimedia resource playing method according to some embodiments.

FIG. 10 is a structural diagram of a multimedia resource playing apparatus according to some embodiments.

FIG. 11 is a structural diagram of a terminal according to some embodiments.

FIG. 12 is a structural diagram of a server according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure and the appended claims.

In the following descriptions, related “some embodiments” describe a subset of all possible embodiments. However, it may be understood that the “some embodiments” May be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

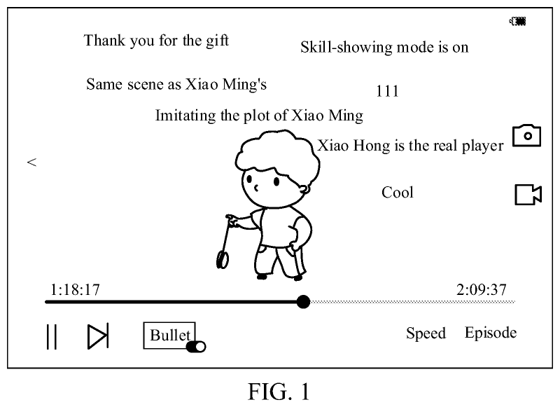

The playback progress bar provided in the related art may be a control for reflect a playback progress of a multimedia resource when a user is watching or listening to the multimedia resource. In addition, by dragging the playback progress bar, a location of interest can be quickly jumped to for watching or listening. Currently, the playback progress bar presents only time information, that is, presents only the playback progress of the multimedia resource. As an example, the multimedia resource is a video, and the playback progress bar may be shown in FIG. 1. In FIG. 1, the playback progress bar presents a total duration of the entire video: “2:09:37”, and a duration of a currently played part of the video: “1:18:17”. The playback progress is represented by using a ratio of the two durations and a location of a slider on the playback progress bar (for example, as shown by a black spot on the playback progress bar in FIG. 1).

Based on this playback progress bar, the user can only drag the playback progress bar left and right to locate a location of interest based on feeling. In such a manner cannot, personalized interest requirements of the user playing the video are not considered. Consequently, the user needs to drag the slider left and right a plurality of times to locate the location of interest, and it is difficult to locate accurately at one time, leading to low efficiency and even causing the user to miss or fail to locate wonderful content of interest, resulting in poor user experience.

To resolve the foregoing technical problem, s provide a multimedia resource playing method. The method can mine degrees of interest of a multimedia playing object (for example, a user) in multimedia resource segments in different time intervals in a multimedia resource to be played. Therefore, a playback progress bar can be generated according to the degrees of interest of the multimedia playing object in the multimedia resource segments in the different time intervals in the multimedia resource to be played. In this case, a location of interest can be intuitively found according to the playback progress bar, without repeating a drag operation a plurality of times. In this way, the location of interest can be quickly and accurately located, and the accuracy and efficiency of jumping to the location of interest can be improved, thereby improving user experience.

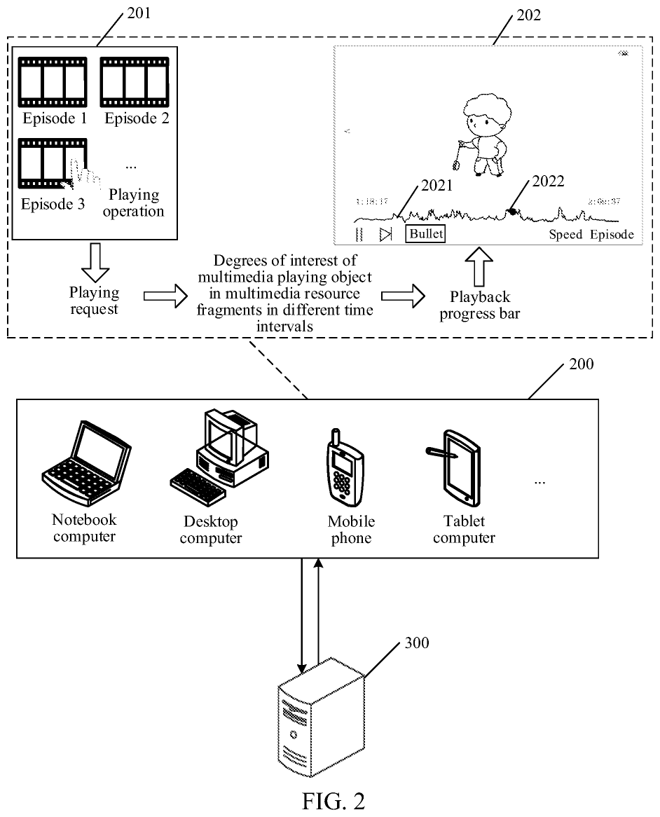

Next, a system architecture of the multimedia resource playing method is described. Referring to FIG. 2, the system architecture includes a terminal 200 and a server 300. The terminal 200 may be installed with a multimedia platform or may access the multimedia platform through a browser. In this way, a multimedia playing object can access the multimedia play platform through the terminal 200 to watch or listen to a multimedia resource. The terminal 200 includes, but is not limited to, a smartphone, a tablet computer, a notebook computer, a desktop computer, an intelligent voice interaction device, a smart home appliance, an in-vehicle terminal, or the like, but is not limited thereto.

The server 300 may provide the terminal 200 with a service for accessing the multimedia resource. The server 300 may be an independent physical server, or may be a server cluster or a distributed system including a plurality of physical servers, or may be a cloud server that provides a cloud computing service. The terminal 200 and the server 300 may be directly or indirectly connected in a wired or wireless communication manner. This is not limited herein. For example, the terminal 200 and the server 300 may be connected through a network. The network may be a wired or wireless network.

The multimedia playing object may be an object that selects a multimedia resource (for example, a multimedia resource to be played) for playing, to watch or listen to the multimedia resource. For example, the multimedia playing object may be a user. The multimedia resource to be played may be a multimedia resource that is triggered by a playing operation and waits to be played. There may be a plurality of types of multimedia resources, which may be, for example, video (such as short videos, movies, or television series episodes) or audio (such as music, audio novels, or radio dramas).

When the multimedia playing object intends to play a multimedia resource to be played, a playing operation may be performed on the multimedia resource to be played. Then, the terminal 200 obtains a playing request generated based on the playing operation.

Due to different types of multimedia resources to be played, playing operations performed on the multimedia resources to be played may be different. If the multimedia resource to be played is a short video, the playing operation may be opening a multimedia platform of the short video, or switching short videos, or selects a short video from all short videos under an account. If the multimedia resource to be played is a movie, the playing operation may be selecting a movie for playing. If the multimedia resource to be played is an episode of a television series, the playing operation may be selecting an episode from a plurality of episodes for playing. If the multimedia resource to be played is audio, the playing operation may be selecting a particular audio for playing, and so on. This is not limited herein.

In some embodiments, description is provided mainly by using an example in which the multimedia resource to be played is a video, and the video may be an episode of a television series. The multimedia playing object opens a television series and enters an episode selection page. For example, as shown by 201 in FIG. 2, a plurality of episodes: episode 1, episode 2, episode 3, . . . , are included. Then, the episode 3 is selected from the plurality of episodes on the episode selection page for playing.

The playing request carries an object identifier of the multimedia playing object and a multimedia identifier of the multimedia resource to be played. The object identifier is used for indicating an object that plays the multimedia resource to be played. The multimedia identifier is used for indicating the played multimedia resource to be played. Because different objects may have different degrees of interest in multimedia resource segments in different time intervals in different multimedia resources, the terminal 200 may obtain, based on the object identifier and the multimedia identifier, degrees of interest of the multimedia playing object in multimedia resource segments in different time intervals in the multimedia resource to be played.

Then, the terminal 200 generates a playback progress bar based on the degrees of interest of the multimedia playing object in the multimedia resource segments in the different time intervals in the multimedia resource to be played. Then, the terminal 200 plays the multimedia resource to be played, and displays the playback progress bar on a playing page of the multimedia resource to be played during the playing of the multimedia resource to be played. The playing page may be shown by 202 in FIG. 2, and the playback progress bar may be shown by 2021. The playback progress bar may be presented in different forms, which may include, for example, a heartbeat curve, a bar chart, and a straight line combined with an interest degree value (where the straight line represents a playback progress, and the value represents the degree of interest). As an example, the playback progress bar shown by 2021 is presented in the form of a heartbeat curve. A horizontal coordinate of the heartbeat curve is the time interval, and a longitudinal coordinate (that is, a height of the heartbeat curve) is the degree of interest.

Combining a progress bar with the degrees of interest of the multimedia playing object in the multimedia resource segments in the different time intervals in the multimedia resource to be played, the playback progress bar provided in some embodiments can be used for indicating a playback progress of the multimedia resource to be played and the degrees of interest of the multimedia playing object in the multimedia resource segments in the different time intervals in the multimedia resource to be played. The playback progress bar provided in some embodiments may be referred to as a cardiogram-style progress bar. The multimedia playing object can learn of the degrees of interest in the multimedia resource segments in the different time intervals based on the playback progress bar, thereby quickly and intuitively finding a location of interest (that is, a time interval). A sliding granularity of the playback progress bar matches a division granularity of the time interval, so that the multimedia playing object can control the playback progress bar to reach the location of interest.

For example, it can be seen from the playback progress bar that a location shown by 2022 corresponds to a higher degree of interest. This indicates that this location may be a location of interest of the multimedia playing object. Therefore, the multimedia playing object can directly control the playback progress bar to reach this location to achieve quick locating.

In some embodiments, the location of interest can be intuitively found according to the playback progress bar, without repeating a drag operation a plurality of times. In this way, the location of interest can be quickly and accurately located, and the accuracy and efficiency of jumping to the location of interest can be improved, thereby improving user experience.

In some embodiments, a computer device may be a server or a terminal, and the method provided in some embodiments may be performed by the terminal or the server alone, or may be performed by the terminal and the server in cooperation with each other. The embodiment corresponding to FIG. 2 is described mainly by using an example in which the method provided in some embodiments is performed by the terminal. When the method provided in some embodiments is performed by the server alone, an execution method is similar to that of the embodiment corresponding to FIG. 2, and mainly, the terminal is replaced with the server.

When the method provided in some embodiments is performed by the terminal and the server in cooperation with each other, an operation that needs to be reflected on a front-end interface may be performed by the terminal, such as displaying a playback progress bar. Some operations that require backend calculation and do not need to be reflected on the front-end interface may be performed by the server, such as obtaining degrees of interest of a multimedia playing object in multimedia resource segments in different time intervals in a multimedia resource to be played and generating a playback progress bar.

In some embodiments, the process of determining a degree of interest may involve user-related data. When various embodiments are applied to a specific product or technology, separate permission or consent from a user is required, and the collection, use, and processing of the relevant data need to comply with relevant laws, regulations, and standards of relevant countries and regions.

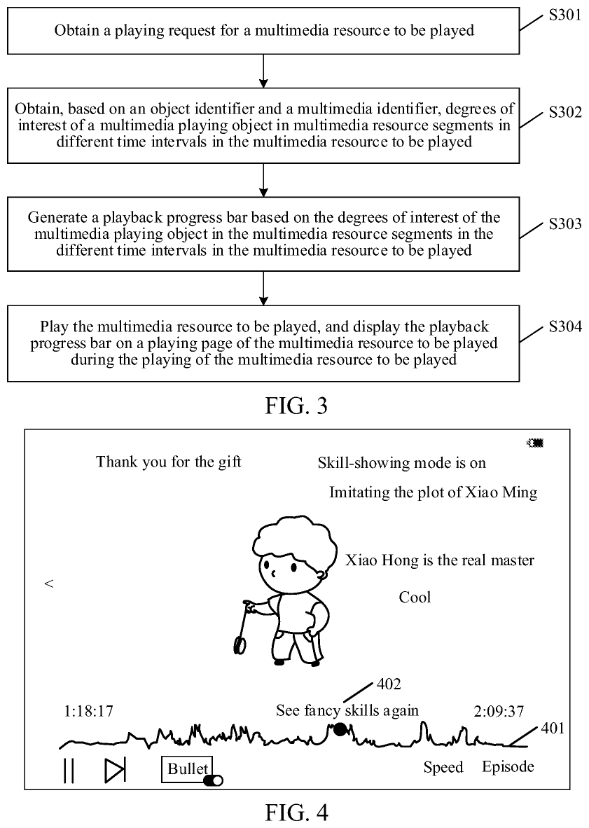

Next, the multimedia resource playing method provided in some embodiments is to be described in detail with reference to the accompanying drawings in which the method is performed by a terminal. Referring to FIG. 3, FIG. 3 is a flowchart of a multimedia resource playing method. The method includes the following operations:

S301: Obtain a playing request for a multimedia resource to be played.

When a multimedia playing object intends to play a multimedia resource to be played, a playing operation may be performed on the multimedia resource to be played. Then, the terminal may obtain a playing request generated based on the playing operation.

In some embodiments, a type of the multimedia resource to be played may be video, audio, or the like. There may be a plurality of cases for the types of video and audio separately. As an example, the multimedia resource to be played is a video and is an episode of a television series. In this case, the multimedia playing object may perform a playing operation on an episode on a particular multimedia platform to trigger a playing request, so that the terminal obtains the playing request. For example, after opening the television series, the multimedia playing object selects an episode of the television series from an episode list to play.

The playing request may be generated by the terminal based on the playing operation. When the method provided in some embodiments is performed by a server, an implementation of S301 may be that the terminal sends the playing request to the server.

It can be understood that, an objective of some embodiments is to combine a progress bar with degrees of interest of a multimedia playing object in multimedia resource segments in different time intervals in a multimedia resource to be played, so that the playback progress bar can reflect degrees of interest of the multimedia playing object in multimedia resource segments in different time intervals, thereby making it easier to locate a location of interest and jump thereto. Therefore, the degrees of interest of the multimedia playing object in the multimedia resource segments in the different time intervals in the multimedia resource to be played need to be obtained. However, different objects may have different degrees of interest in multimedia resource segments in different time intervals in different multimedia resources. For this reason, it is necessary to enable the terminal to determine which object and which multimedia resource it is. Therefore, the playing request obtained by the terminal may include an object identifier and a multimedia identifier.

The object identifier is used for indicating an object that plays the multimedia resource to be played, to determine an identity of the multimedia playing object. The object identifier may be, for example, an account used by the multimedia playing object to log in or access the multimedia platform, or may be an identifier of the terminal used. The multimedia identifier is used for indicating the played multimedia resource to be played, to determine the multimedia resource to be played. The multimedia identifier may be, for example, a name or a number of the multimedia resource to be played.

S302: Obtain, based on the object identifier and the multimedia identifier, degrees of interest of the multimedia playing object in multimedia resource segments in different time intervals in the multimedia resource to be played.

The terminal may obtain, according to the object identifier and the multimedia identifier, degrees of interest of the multimedia playing object in the multimedia resource segments in the different time intervals in the multimedia resource to be played. A division granularity of the time interval may be configured according to actual requirements, or may be determined according to a sliding granularity of the playback progress bar. The sliding granularity may represent a minimum time unit by which the multimedia resource to be played can jump when a slider on the playback progress bar moves once. The sliding granularity may be pre-configured, for generating a playback progress bar that can jump according to the sliding granularity. For example, the sliding granularity of the playback progress bar is S second. In this case, the multimedia resource to be played can be divided into time intervals with the division granularity of S seconds.

S303: Generate a playback progress bar based on the degrees of interest of the multimedia playing object in the multimedia resource segments in the different time intervals in the multimedia resource to be played.

The terminal draws a playback progress bar according to degrees of interest of the multimedia playing object in multimedia resource segments in different time intervals. A sliding granularity of the playback progress bar matches a division granularity of the time interval. The playback progress bar may be presented in different forms, which may include, for example, a heartbeat curve, a bar chart, and a straight line combined with an interest degree value (where the straight line represents a playback progress, and the value represents the degree of interest). In some embodiments, the presentation form of the heartbeat curve is mainly used as an example. In the presentation form of the heartbeat curve, the terminal may draw a heartbeat curve based on degrees of interest with a horizontal coordinate as the time interval and a longitudinal coordinate as the degree of interest. The obtained playback progress bar may be referred to as a cardiogram-style progress bar.

If the division granularity of the time interval is configured according to an actual requirement, the sliding granularity of the playback progress bar may also be configured according to the actual requirement, so that the sliding granularity of the playback progress bar matches the division granularity of the time interval. If the division granularity of the time interval is determined according to the sliding granularity of the playback progress bar, during generation of a playback progress bar, a playback progress bar with the foregoing sliding granularity is generated, so that the sliding granularity of the playback progress bar matches the division granularity of the time interval. In some embodiments, the matching herein may mean that the sliding granularity of the playback progress bar is consistent with the division granularity of the time interval. For example, if the sliding granularity of the playback progress bar is S seconds, the division granularity of the time interval is S seconds.

The matching between the sliding granularity of the playback progress bar and the division granularity of the time interval ensures that the multimedia playing object can know a degree of interest in a multimedia resource segment in each time interval that can be jumped to, so that quick and accurate locating and jumping can be achieved according to the degree of interest.

S304: Play the multimedia resource to be played, and display the playback progress bar on a playing page of the multimedia resource to be played during the playing of the multimedia resource to be played.

Then, the terminal plays the multimedia resource to be played, and displays the playback progress bar on the playing page of the multimedia resource to be played during the playing of the multimedia resource to be played. Because the playback progress bar is generated according to the degrees of interest of the multimedia playing object in the multimedia resource segments in the different time intervals in the multimedia resource to be played, the playback progress bar can indicate a playback progress of the multimedia resource to be played and the degrees of interest of the multimedia playing object in the multimedia resource segments in the different time intervals in the multimedia resource to be played. In this way, the multimedia playing object can understand, based on the playback progress bar, degrees of interest in multimedia resource segments in different time intervals. This enriches information presentation on the playback progress bar, so that a location of interest (that is, a time interval) can be quickly and intuitively found.

FIG. 4 is an example diagram of a playing page of a multimedia resource to be played. Referring to FIG. 4, a playback progress bar may be displayed on the playing page, as shown by 401 in FIG. 4.

It can be learned from the foregoing technical solutions that, after a multimedia playing object performs a play operation on a multimedia resource to be played, a playing request can be generated based on the play operation, so that a playing request for the multimedia resource to be played is obtained. The playing request carries an object identifier of the multimedia playing object and a multimedia identifier of the multimedia resource to be played. Therefore, degrees of interest of the multimedia playing object in multimedia resource segments in different time intervals in the multimedia resource to be played can be obtained based on the object identifier and the multimedia identifier. A playback progress bar is generated based on the degrees of interest of the multimedia playing object in the multimedia resource segments in the different time intervals in the multimedia resource to be played, the multimedia resource to be played is played, and the playback progress bar is displayed on a playing page of the multimedia resource to be played during the playing of the multimedia resource to be played. The playback progress bar is used for indicating a playback progress of the multimedia resource to be played and the degrees of interest of the multimedia playing object in the multimedia resource segments in the different time intervals in the multimedia resource to be played. Therefore, the multimedia playing object can learn of the degrees of interest in the multimedia resource segments in the different time intervals based on the playback progress bar, thereby quickly and intuitively finding a location of interest (that is, a time interval). A sliding granularity of the playback progress bar matches a division granularity of the time interval, so that the multimedia playing object can control the playback progress bar to reach the location of interest. In other words, the location of interest may be intuitively found according to the playback progress bar, without repeating a drag operation a plurality of times. In this way, the location of interest can be quickly and accurately located, and the accuracy and efficiency of jumping to the location of interest can be improved, thereby improving user experience.

In some embodiments, the most critical problem is how to obtain degrees of interest of the multimedia playing object in multimedia resource segments in different time intervals. Some embodiments provide a plurality of obtaining manners. In one obtaining manner, the degrees of interest of the multimedia playing object in the multimedia resource segments in the different time intervals are calculated in advance, and stored in an interest degree storage space (such as a database or a hard disk). When needed, the degrees of interest can be directly obtained from the interest degree storage space through searching.

In some embodiments, the interest degree storage space may store degrees of respective interest of a plurality of objects in multimedia resource segments in different time intervals in different multimedia resources, and the plurality of objects include the multimedia playing object. For example, the interest degree storage space stores degrees of interest of an object 1 in multimedia resource segments in different time intervals in a multimedia resource 1, degrees of interest of an object 2 in the multimedia resource segments in the different time intervals in the multimedia resource 1, degrees of interest of the object 2 in multimedia resource segments in different time intervals in a multimedia resource 2, . . . , degrees of interest of an object N in the multimedia resource segments in the different time intervals in the multimedia resource 1, and degrees of interest of the object N in multimedia resource segments in different time intervals in a multimedia resource N. The object 1, the object 2, . . . , and the object N respectively have corresponding object identifiers. The multimedia resource 1, the multimedia resource 2, . . . , and the multimedia resource N respectively have corresponding multimedia identifiers. In this case, an implementation of S302 may be that the terminal searches, according to the object identifier and the multimedia identifier, the interest degree storage space for the degrees of interest of the multimedia playing object in the multimedia resource segments in the different time intervals in the multimedia resource to be played. For example, the object identifier obtained by the terminal is consistent with the object identifier of the object 1, and the multimedia identifier obtained by the terminal is consistent with the multimedia identifier of the multimedia resource 1. In this case, the degrees of interest of the object 1 in the multimedia resource segments in the different time intervals in the multimedia resource 1 can be obtained from the interest degree storage space. In other words, the object 1 is the multimedia playing object, and the multimedia resource 1 is the multimedia resource to be played.

The degrees of interest of the multimedia playing object in the multimedia resource segments in the different time intervals in the multimedia resource to be played are calculated in advance, and therefore, can be directly found from the interest degree storage space during the playing of the multimedia resource to be played. In this way, the amount of calculation is reduced and the efficiency of playing and displaying is improved.

The degrees of interest stored in the interest degree storage space can be updated regularly. Alternatively, the degrees of interest stored in the interest degree storage space can be updated when a relatively large change in degrees of interest is detected. A manner of updating the degrees of interest is not limited herein.

In some embodiments, there may be a large number of multimedia resources on the multimedia platform, and the number of common objects of the multimedia platform may also be very large. However, among these objects, some objects may have relatively high activity levels, for example, often play multimedia resources through the multimedia platform. In this case, degrees of interest of these objects in multimedia resource segments in different time intervals in the multimedia resources may need to be frequently obtained. However, some objects may have relatively low activity levels. For example, only use the multimedia platform occasionally. In this case, degrees of interest of these objects in multimedia resource segments in different time intervals in the multimedia resource can be obtained only once in a long time.

Based on the foregoing characteristics, considering the balance between storage costs and interest degree obtaining efficiency, in the interest degree storage space, degrees of interest of an object with a relatively high activity level in multimedia resource segments in different time intervals in the multimedia resource may be calculated in advance and stored in the interest degree storage space. In this way, for the object with the relatively high activity level, the degrees of interest in the multimedia resource segments in the different time intervals can be obtained in a manner of searching in the interest degree storage space. In this case, before S302 is performed, the terminal may obtain interactive data of the multimedia playing object based on the object identifier, and then determine an activity level of the multimedia playing object according to the interactive data. If the activity level of the multimedia playing object is higher than a first threshold, it indicates that the multimedia playing object is an object with a relatively high activity level, and its degrees of interest in multimedia resource segments in different time intervals in different multimedia resources are stored in the interest degree storage space. Therefore, the operation shown in S302 can be performed. The interactive data may be data on interaction of the multimedia playing object on the multimedia platform, and the interaction may include, for example, playing a multimedia resource, posting a comment, or publishing bullet comment content.

The degrees of interest of the object with the relatively high activity level in the multimedia resource segments in the different time intervals in the different multimedia resources are stored in the interest degree storage space activity level, so that not only the efficiency of playing and displaying can be improved, but also the storage space can be saved and the storage pressure can be reduced to some extent.

In another obtaining manner, when the multimedia resource to be played needs to be played, the degrees of interest of the multimedia playing object in the multimedia resource segments in the different time intervals in the multimedia resource to be played may be calculated in real time. It can be understood that, the real-time calculation manner is similar to the pre-calculation manner, except that the calculation timing is different mainly. In some embodiments, the interest degree calculation manner is described in detail by using the real-time calculation manner as an example.

A possible calculation manner provided in some embodiments may be as follows: The terminal obtains a first object interest tag of the multimedia playing object according to the object identifier, and obtains, according to the multimedia identifier, multimedia resource information of the multimedia resource segments in the different time intervals in the multimedia resource to be played. Then, the degrees of interest of the multimedia playing object in the multimedia resource segments in the different time intervals in the multimedia resource to be played are determined based on the first object interest tag and the multimedia resource information of the multimedia resource segments in the different time intervals. The first object interest tag may be determined according to historical playing data of the multimedia playing object and can reflect content of interest of the multimedia playing object. The first object interest tag may include a type of a multimedia resource, a crew member, and the like.

As an example, the multimedia resource is an episode of a television series. In this case, the first object interest tag may include the type of the multimedia resource and a crew member. The type of the multimedia resource may be, for example, costume, family, or campus. The crew member may be, for example, an actor A or a production company B. As an example, the multimedia resource is music. In this case, the first object interest tag may include the type of the multimedia resource and a crew member. The type of the multimedia resource may be, for example, sad, light music, rock, or ancientry. The crew member may be, for example, a singer C.

In some embodiments, based on the foregoing analysis of features of a large number of objects on the multimedia platform, considering the balance between the storage costs and the interest degree obtaining efficiency, to reduce consumption of computing resources caused by frequent calculations, real-time calculation can be used for an object with a relatively low activity level. In this case, before S302 is performed, the terminal may obtain interactive data of the multimedia playing object based on the object identifier, and then determine an activity level of the multimedia playing object according to the interactive data. If the activity level of the multimedia playing object is lower than a first threshold, it indicates that the multimedia playing object is an object with a relatively low activity level, and its degrees of interest in multimedia resource segments in different time intervals in different multimedia resources are not stored in the interest degree storage space, and real-time calculation is required. Therefore, the operation shown in S302 can be performed.

Through the real-time calculation of the degrees of interest of the object with the relatively low activity level in the multimedia resource segments in the different time intervals in the different multimedia resources, the consumption of computing resources caused by frequent calculations can be reduced and computing pressure can be reduced.

In some embodiments, the multimedia resource information may include at least one of multimedia resource content and bullet comment content. The multimedia resource content directly reflects content of different multimedia resources segments. The bullet comment content is usually content (such as text or an emoticon) posted by an object watching the multimedia resource to be played in response to a multimedia resource segment. For example, as shown in FIG. 4, the bullet comment content may include “Thank you for the gift”, “Skill-showing mode is on”, “Imitating the plot of Xiao Ming”, “Xiao Hong is the real master”, “Cool”, or the like. The bullet comment content can reflect the content of the multimedia resource segment to some extent. A degree of interest of the multimedia playing object in the bullet comment content in the multimedia resource segment can reflect a degree of interest of the multimedia playing object in the multimedia resource segment, thereby helping determine the degree of interest of the multimedia playing object in the multimedia resource segment.

Usually, the bullet comment content can be obtained directly by extracting a bullet comment on the playing interface. The obtaining manner is simple and convenient. Therefore, in some embodiments, the multimedia resource information includes at least one piece of bullet comment content in the multimedia resource segment. In this way, the degrees of interest of the multimedia playing object in the multimedia resource segments in the different time intervals in the multimedia resource to be played are determined. In this case, the manner of determining, based on the first object interest tag and the multimedia resource information of the multimedia resource segments in the different time intervals, the degrees of interest of the multimedia playing object in the multimedia resource segments in the different time intervals in the multimedia resource to be played may be: for a multimedia resource segment in any time interval, calculating, according to the first object interest tag and any piece of bullet comment content in the multimedia resource segment, a degree of interest of the multimedia playing object in the any piece of bullet comment content; and performing weighted summation based on the degree of interest in the any piece of bullet comment content to obtain a degree of interest of the multimedia playing object in the multimedia resource segment. A weight used in the weighted summation may be popularity of the bullet comment content, and may be represented by using a ratio of the number of likes of the bullet comment content to a total number of likes of all bullet comment content of the multimedia resource to be played.

All time intervals are respectively calculated in the foregoing manner to obtain the degrees of interest of the multimedia playing object in the multimedia resource segments in the different time intervals in the multimedia resource to be played. In such a manner, the complexity of interest degree calculation can be reduced, the interest degree calculation can be simplified, and the calculation efficiency can be improved.

For example, the any time interval is a time interval t, a multimedia resource segment in the time interval t may include a plurality of pieces of bullet comment content, and the any piece of bullet comment content is bullet comment content b. In this case, a degree of interest of the multimedia playing object in the bullet comment content b is first calculated and expressed as p_in_u[b]. The weight may be expressed as wb. In this case, the degree of interest of the multimedia playing object in the multimedia resource segment in the time interval t is sum_b (p_in_u[b]*wb). Herein, wb is popularity of the bullet comment content b, and wb is equal to the number of likes of bullet comment content b divided by a total number of likes of all bullet comment content of the multimedia resource to be played.

In some embodiments, the degrees of interest of the multimedia playing object in the multimedia resource segments in the different time intervals in the multimedia resource to be played may be determined by using an interest degree prediction model. That is, the first object interest tag and the multimedia resource information of the multimedia resource segments in the different time intervals are input into the interest degree prediction model to output the degrees of interest of the multimedia playing object in the multimedia resource segments in the different time intervals in the multimedia resource to be played.

In this case, the manner of calculating, according to the first object interest tag and any piece of bullet comment content in the multimedia resource segment, a degree of interest of the multimedia playing object in the any piece of bullet comment content may be: encoding the first object interest tag to obtain a first object interest feature vector, and encoding the any piece of bullet comment content in the multimedia resource segment to obtain a bullet comment feature vector of the any piece of bullet comment content; then performing attention interaction on the first object interest feature vector and the bullet comment feature vector of the any piece of bullet comment content to obtain a first fusion feature vector of the any piece of bullet comment content; and then, performing interest degree prediction according to the first fusion feature vector of the any piece of bullet comment content to obtain the degree of interest of the multimedia playing object in the any piece of bullet comment content.

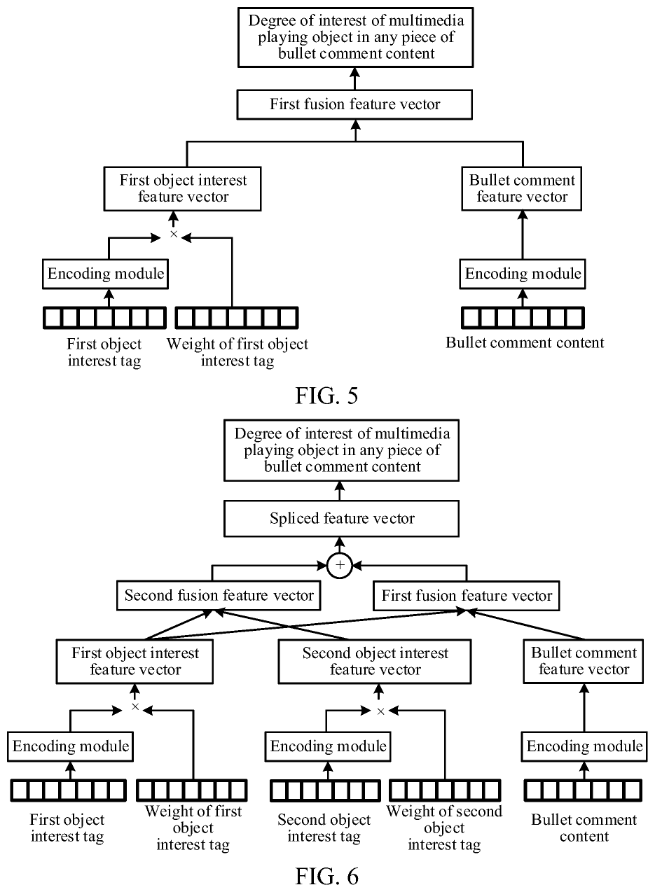

FIG. 5 is a schematic structural diagram of an interest degree prediction model. The interest degree prediction model may include an encoding module, a first fusion module, and a prediction module. A first object interest tag and bullet comment content are used as inputs of the interest degree prediction model. The encoding module encodes the first object interest tag to obtain a first object interest feature vector, and the encoding module encodes the bullet comment content to obtain a bullet comment feature vector. The first fusion module performs attention interaction on the first object interest feature vector and the bullet comment feature vector to obtain a first fusion feature vector. Then, the prediction module performs interest degree prediction on the first fusion feature vector to obtain a degree of interest of a multimedia playing object in the bullet comment content. There may be a plurality of first object interest tags, and different first object interest tags may have different importance for interest degree prediction. Therefore, a weight of the first object interest tag may also be used as an input of the interest degree prediction model, thereby obtaining the first object interest feature vector by combining the weight of the first object interest tag with the first object interest tag. The encoding module may be a Transformer-Encoder.

It can be understood that, each piece of bullet comment content has a corresponding publishing object. The publishing object may be an object that publishes the bullet comment content, for example, a user that plays the multimedia resource to be played and makes comments on a multimedia resource segment. Bullet comment content published by different publishing objects may reflect degrees of interest thereof in a multimedia resource segment. If the multimedia playing object has a similar interest as the publishing object, the multimedia playing object may also have a similar degree of interest in the multimedia resource segment as the publishing object. Therefore, in some embodiments, a second object interest tag of the publishing object may be used to assist in determining the degree of interest of the multimedia playing object in the bullet comment content. In this regard, a manner of performing interest degree prediction according to a first fusion feature vector of any piece of bullet comment content to obtain a degree of interest of the multimedia playing object in the any piece of bullet comment content may be as follows: A terminal obtains a second object interest tag of a publishing object of the any piece of bullet comment content, encodes the second object interest tag to obtain a second object interest feature vector, and performs attention interaction on the first object interest feature vector and the second object interest feature vector to obtain a second fusion feature vector. The second fusion feature vector can reflect the consistency of interests between the multimedia playing object and the publishing object. The more consistent the interests are, the higher degree of interest the multimedia playing object may have in the bullet comment content published by the publishing object. This assists in predicting the degree of interest of the multimedia playing object in the bullet comment content. Then, feature splicing is performed on the first fusion feature vector and the second fusion feature vector to obtain a spliced feature vector, so that interest degree prediction is performed according to the spliced feature vector to obtain the degree of interest of the multimedia playing object in the any piece of bullet comment content.

FIG. 6 is a schematic structural diagram of another interest degree prediction model. The interest degree prediction model may include an encoding module, a first fusion module, a second fusion module, a splicing module, and a prediction module. A first object interest tag, a second object interest tag, and bullet comment content are used as inputs of the interest degree prediction model. The encoding module encodes the first object interest tag to obtain a first object interest feature vector. The encoding module encodes the second object interest tag to obtain a second object interest feature vector. In addition, the encoding module encodes the bullet comment content to obtain a bullet comment feature vector. The first fusion module performs attention interaction on the first object interest feature vector and the bullet comment feature vector to obtain a first fusion feature vector. In addition, the second fusion module performs attention interaction on the first object interest feature vector and the second object interest feature vector to obtain a second fusion feature vector. Then, the splicing module performs feature splicing on the first fusion feature vector and the second fusion feature vector to obtain a spliced feature vector, so that the prediction module performs interest degree prediction according to the spliced feature vector to obtain the degree of interest of the multimedia playing object in the any piece of bullet comment content.

There may be a plurality of first object interest tags and a plurality of second object interest tags, and different first object interest tags or second object interest tags may have different importance for interest degree prediction. Therefore, a weight of the first object interest tag and a weight of the second object interest tag may also be used as inputs of the interest degree prediction model, thereby obtaining the first object interest feature vector by combining the weight of the first object interest tag with the first object interest tag, and obtaining the second object interest feature vector by combining the weight of the second object interest tag with the second object interest tag.

Various network structures can be used for the interest degree prediction model. Therefore, FIG. 5 and FIG. 6 are each an example only, and do not constitute any limitation herein.

It is to be understood that, the interest degree prediction model used in some embodiments may be pre-trained, and training data used for the training may be liking interaction behavior data for sample bullet comment content. If a user (for example, a sample multimedia playing object) likes the sample bullet comment content, it means that the user is interested in the sample bullet comment content. In this case, the data is positive sample data. Otherwise, the data is negative sample data. Based on the foregoing liking interaction behavior data, a first sample object interest tag of the sample multimedia playing object, a second sample object interest tag of a sample publishing object, and sample bullet comment content may be obtained. The first sample object interest tag and the sample bullet comment content are used as inputs to process the input data by using a method similar to the processing method described in the embodiment corresponding to FIG. 5 to achieve model training. Alternatively, the first sample object interest tag, the second sample object interest tag, and the sample bullet comment content are used as inputs to process the input data by using a method similar to the processing method described in the embodiment corresponding to FIG. 6 to achieve model training. After convergence of the model training, the interest degree prediction model is obtained. In this way, the degree of interest of the multimedia playing object in the bullet comment content can be output for the multimedia resource to be played.

After the degree of interest of the multimedia playing object in the any piece of bullet comment content is obtained, bullet comment content whose interest degree reaches a second threshold may also be recorded. In this way, when a slider of the playback progress bar moves to a first time interval, that is, when the multimedia playing object switches to a first time interval by using the playback progress bar, the terminal preferentially presents, in response to the movement of the slider of the playback progress bar to the first time interval, target bullet comment content on the playing page of the multimedia resource to be played. The target bullet comment content is bullet comment content whose interest degree reaches the second threshold, and the target bullet comment content belongs to at least one piece of bullet comment content of a multimedia resource segment in the first time interval.

In some embodiments, when the multimedia playing object determines a time interval of interest according to a tempting degree on the playback progress bar, the multimedia playing object can use the playback progress bar to switch to this time interval. To assist the multimedia playing object in determining that the time interval is a location of interest, in some embodiments, description information of the multimedia resource segments in the different time intervals may also be generated. In this way, in a process of playing the multimedia resource to be played, the terminal may control, in response to a control operation for the slider on the playback progress bar, the slider to move to a second time interval, and present the description information of a multimedia resource segment in the second time interval. The description information may be used for summarizing main content of the multimedia resource segment in the time interval, so that the multimedia playing object can understand, according to the description information, content to be played in the multimedia resource segment in the time interval, to assist the multimedia playing object in determining points of interest. The control operation may be various operations of controlling the slider to move to the second time interval, and may be, for example, a drag operation and a click/tap operation. The drag operation is to drag the slider to move to the second time interval. The click/tap operation may be to click/tap a location to cause the slider to move to a time interval corresponding to the location.

For example, as shown in FIG. 4, it is assumed that the multimedia resource to be played in FIG. 4 is an episode of a television series about playing yo-yo, and in such an episode, the multimedia playing object is more interested in various fancy ways of playing yo-yo, cool actions, and the like. When the multimedia playing object drags the slider (as shown by the black spot in FIG. 4) to the second time interval according to an interest degree on the playback progress bar, description information of “See fancy skills again” shown by 402 may be presented. Through this description information, the multimedia playing object can know that the multimedia resource segment in the second time interval may play fancy ways of playing yo-yo and cool actions. This assists the multimedia playing object in determining that the multimedia resource segment in this time interval is of interest thereto.

In some embodiments, the description information may be predicted by using a description prediction model. The description information is a personalized description of the multimedia playing object, the description information may be generated based on a first object interest tag of the multimedia playing object. That is, some embodiments of generating description information of the multimedia resource segments in the different time intervals is: obtaining a first object interest tag of the multimedia playing object according to the object identifier, and obtaining, according to the multimedia identifier, multimedia resource information of the multimedia resource segments in the different time intervals in the multimedia resource to be played; and then, for a multimedia resource segment in any time interval, generating description information of the multimedia resource segment based on the first object interest tag and multimedia resource information of the multimedia resource segment by using the description prediction model.

The multimedia resource information herein is similar to the foregoing multimedia resource information. The multimedia resource information may include at least one of multimedia resource content and bullet comment content. In some embodiments, the description is provided mainly by using an example in which the multimedia resource information includes at least one piece of bullet comment content of the multimedia resource segment. There may be a large amount of bullet comment content. Some bullet comment content has higher interaction popularity, which is conducive to generating description information. Some bullet comment content has lower interaction popularity, which is not conducive to generating description information. Therefore, to improve the accuracy of generating description information, the first object interest tag and bullet comment content whose interaction popularity is top m in the time interval may be used as inputs of the description prediction model to generate description information.

In the process of generating the description information, the manner of processing the first object interest tag to generate a corresponding first object interest feature vector is similar to the manner shown in FIG. 5 or FIG. 6. For example, referring to the module on the leftmost side of FIG. 5 or FIG. 6 that processes the first object interest tag process, the first object interest tag and the weight of the first object interest tag are input, and the first object interest feature vector is output. This vector can improve user personalization of generating the description information.

In some embodiments, the description prediction model has a relatively large scale, and manually constructed description information is limited. Therefore, to improve training precision and a convergence speed of the description prediction model, a manner combining pre-training and fine-tuning may be used during the training of the description prediction model. That is, first, a first sample object interest tag of a multimedia playing sample object is obtained, and multimedia resource information of a sample multimedia resource is obtained. In this way, an initial network model is pre-trained based on the first sample object interest tag and the multimedia resource information with title information of the sample multimedia resource as a training target to obtain a pre-trained model. There are a large number of sample multimedia resources with title information, and these sample multimedia resources, such as short videos on multimedia platforms, can be directly obtained without manual annotation. Therefore, performing pre-training by using sample multimedia resources with title information can obtain a pre-trained model with a good status. Then, a second sample object interest tag is obtained, and a sample multimedia resource segment is obtained from the sample multimedia resource. The pre-trained model is trained (that is, fine-tuned) based on the second sample object interest tag and multimedia resource information of the sample multimedia resource segment to obtain the description prediction model. A second sample object may be a sample publishing object. The sample publishing object is an object that publishes bullet comment content for the sample multimedia resource segment. An interest tag corresponding to the second sample object is referred to as a second sample object interest tag.

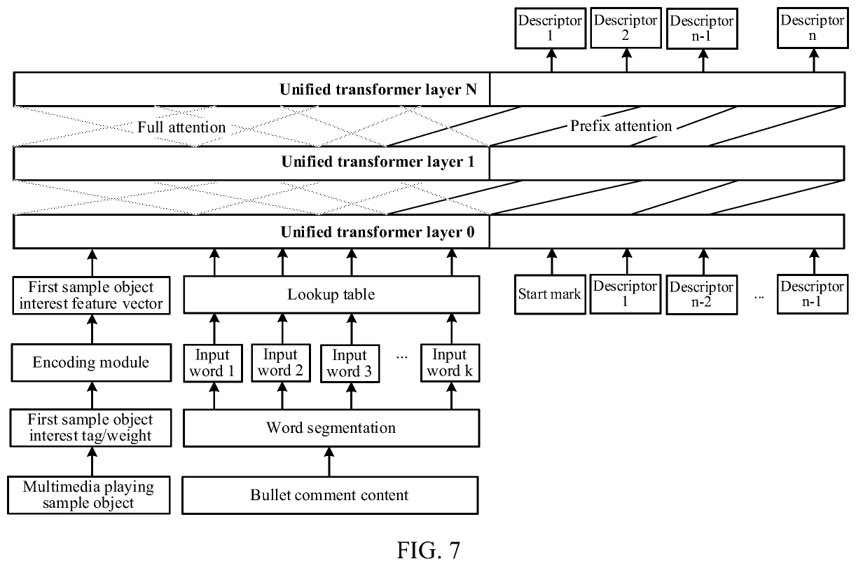

Various network structures can be used for the description prediction model. This is not limited herein. In some embodiments, description is provided mainly by using an example in which a unified transformer model is used as a basic model structure for each of an initial network model, a pre-trained model, and a description prediction model. As shown in FIG. 7, the unified transformer model includes a unified transformer layer 1, a unified transformer layer 2, and a unified transformer layer N. First, pre-training is performed on a large number of sample multimedia resources (such as short videos) with title information on the multimedia platform. An object whose degree of completing the short video meets a particular threshold is used as a user (that is, a multimedia play sample object) interested in the short video. The first sample object interest tag of the multimedia playing sample object is input into the encoding module. In addition, bullet comment content whose interaction popularity of the short video is top m is input into the encoding module. In this way, a first sample object interest feature vector is obtained. The initial network model performs calculation (that is, bidirectional self-attention) on the input first sample object interest feature vector through full attention.

In a generation part, the title information of the short video is used as a target, and prefix attention is used for the generation part. That is, during generation in each operation, only Attention from the operation to a previous location can be calculated. Through such large-scale pre-training, the initial network model initial shown in FIG. 7 can be initialized to a better state to obtain the pre-trained model.

After the foregoing large-scale pre-training is completed, fine-tuning is then performed in a time interval in which the user is interested. An interest tag of the sample publishing object, namely, the second sample object interest tag, and the bullet comment content (that is, multimedia resource information of a sample multimedia resource segment) whose interaction popularity is top m in the time interval are used as input features of the model. A training target of the fine-tuning phase is artificially constructed description information.

In FIG. 7, for the input bullet comment content whose interaction popularity is top m in the time interval, word segmentation may be performed on the bullet comment content to obtain a plurality of input words: an input word 1, an input word 2, an input word 3, . . . , and an input word k. Then, interpolation calculation is performed on the plurality of input words by using a lookup table module, and a result is sent to the input part. Then, description information is generated through the generation part based on the plurality of input words. The description information includes a plurality of descriptors (for example, a descriptor 1, a descriptor 2, . . . , a descriptor n−1, and a descriptor n). During generation in each operation, only Attention from the operation to a previous location can be calculated. A start mark in FIG. 7 indicates the start of predicting the description information. In a first operation, the descriptor 1 is obtained through calculation obtain. In a second, the descriptor 2 is obtained based on the Attention from this operation to the previous location (including the descriptor 1). By analogy, in an (n−1)^{th} operation, the descriptor n−1 is obtained based on the Attention from this operation to the previous location (including a descriptor n−2). In an n^{th} operation, the descriptor n is obtained based on the Attention from this operation to the previous location (including the descriptor n−1).

In some embodiments, tempting degrees of the multimedia playing object for the multimedia resource segments in the different time intervals in the multimedia resource to be played are constructed through joint modeling of the multimedia resource information of the multimedia resource to be played and the first object interest tag. The playback progress bar shown in FIG. 1 is replaced with a cardiogram-style progress bar shown in FIG. 4. A height of a heartbeat curve in the cardiogram-style progress bar represents a possible degree of interest of the multimedia playing object in this time interval, making it easier for the user to intuitively find a part of interest. In addition, when the multimedia playing object drags the cardiogram-style progress bar, as a dragging location changes, description information at the location is dynamically displayed, and bullet comment content of interest is selected for preferential display. This enables the multimedia playing object to quickly locate and jump to the location of interest through the cardiogram-style progress bar, thereby improving use experience of the playback progress bar, and further improving user experience.

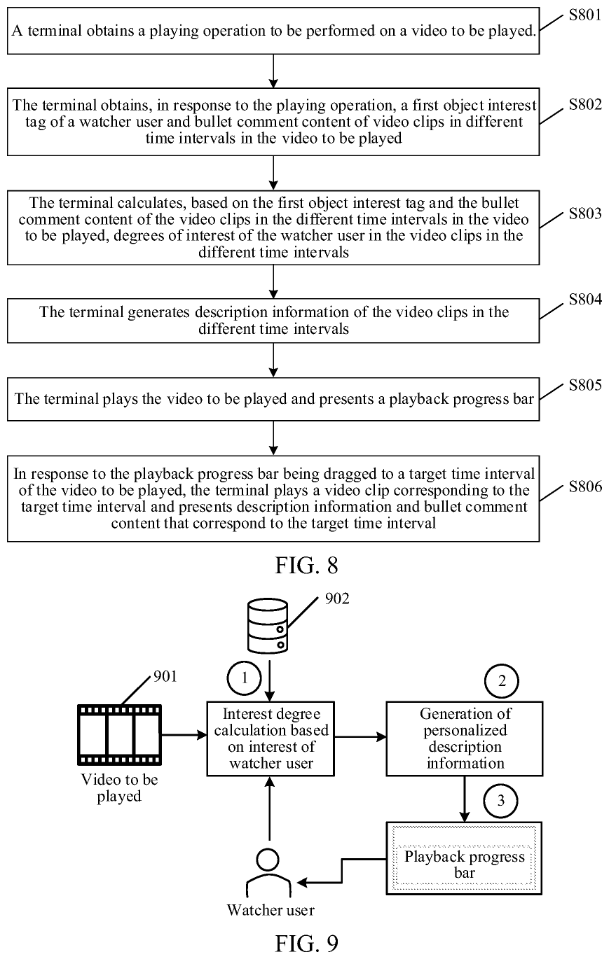

Based on the foregoing description, an overall procedure of the multimedia resource playing method provided in some embodiments is to be described below with reference to an actual application scenario. In the application scenario, the multimedia playing object may be a user. In this case, the multimedia playing object may be referred to as a watcher user. The multimedia resource to be played may be a video to be played. The multimedia resource segment may be a video clip. The multimedia resource information may be bullet comment content. In this case, the overall procedure of the multimedia resource playing method may be shown in FIG. 8. The method may be performed by a terminal and includes the following operations:

S801: The terminal obtains a playing operation to be performed on the video to be played.

S802: The terminal obtains, in response to the playing operation, a first object interest tag of the watcher user and bullet comment content of video clips in different time intervals in the video to be played.

A procedure architecture of the multimedia resource playing method may be shown in FIG. 9. Others user that have watched the video to be played can post corresponding bullet comment content for different video clips during the watching of the video to be played (as shown by 901). The bullet comment content may be stored in a bullet comment content database (as shown by 902). When receiving the playing operation for the video to be played, the terminal can obtain the bullet comment content from the bullet comment content database.

S803: The terminal calculates, based on the first object interest tag and the bullet comment content of the video clips in the different time intervals in the video to be played, degrees of interest of the watcher user in the video clips in the different time intervals.

The first object interest tag can reflect the interest of the watcher user. Therefore, operation S803 may be referred to as interest degree calculation based on the interest of the watcher user, referring to an operation shown by \textcircled{1} in FIG. 9.

S804: The terminal generates description information of the video clips in the different time intervals.

The description information may be generated according to the first object interest tag of the watcher user and meets a personalized requirement of the watcher user. Therefore, operation S804 may be referred to as generation of personalized description information, referring to an operation shown by \textcircled{2} in FIG. 9.

S805: The terminal plays the video to be played and presents a playback progress bar.

For S805, refer to an operation shown by \textcircled{3} in FIG. 9. The playback progress bar is generated based on the degrees of interest of the watcher user in the video clips in the different time intervals.

S806: In response to the playback progress bar being dragged to a second time interval of the video to be played, the terminal plays a video clip corresponding to the second time interval and presents description information and bullet comment content that correspond to the second time interval.

The watcher user can refer to degrees of interest for estimated location switching. When a time interval, for example, the second time interval, is determined as a location of interest according to a degree of interest reflected on the playback progress bar, the playback progress bar may be dragged to the second time interval, to switch to the video clip corresponding to the second time interval for playing and present the description information and the bullet comment content that correspond to the second time interval. This helps the watcher user to find a watching location of interest more intuitively.

Some embodiments further provide a multimedia resource playing apparatus 1000. The multimedia resource playing apparatus 1000 includes an obtaining unit 1001, a generation unit 1002, a playing unit 1003, and a display unit 1004.

The obtaining unit 1001 is configured to obtain a playing request for a multimedia resource to be played, the playing request carrying an object identifier of a multimedia playing object and a multimedia identifier of the multimedia resource to be played.

The obtaining unit 1001 is further configured to obtain, based on the object identifier and the multimedia identifier, degrees of interest of the multimedia playing object in multimedia resource segments in different time intervals in the multimedia resource to be played.

The generation unit 1002 is configured to generate a playback progress bar based on the degrees of interest of the multimedia playing object in the multimedia resource segments in the different time intervals in the multimedia resource to be played, a sliding granularity of the playback progress bar matching a division granularity of the time interval.

The playing unit 1003 is configured to play the multimedia resource to be played.

The display unit 1004 is configured to display the playback progress bar on a playing page of the multimedia resource to be played during the playing of the multimedia resource to be played, the playback progress bar being used for indicating a playback progress of the multimedia resource to be played and the degrees of interest of the multimedia playing object in the multimedia resource segments in the different time intervals in the multimedia resource to be played.

In some embodiments, the obtaining unit 1001 is specifically configured to:

search, according to the object identifier and the multimedia identifier, an interest degree storage space for the degrees of interest of the multimedia playing object in the multimedia resource segments in the different time intervals in the multimedia resource to be played, the interest degree storage space storing degrees of respective interest of a plurality of objects in multimedia resource segments in different time intervals in different multimedia resources, and the plurality of objects including the multimedia playing object.

In some embodiments, the apparatus further includes a determining unit.

The determining unit is configured to: obtain interactive data of the multimedia playing object based on the object identifier;

determine an activity level of the multimedia playing object according to the interactive data; and

in a case that the determining unit determines that the activity level of the multimedia playing object is higher than a first threshold, trigger the obtaining unit 1001 to perform the operation of searching, according to the object identifier and the multimedia identifier, an interest degree storage space for the degrees of interest of the multimedia playing object in the multimedia resource segments in the different time intervals in the multimedia resource to be played.

In some embodiments, the obtaining unit 1001 is configured to:

obtain a first object interest tag of the multimedia playing object according to the object identifier, and obtain, according to the multimedia identifier, multimedia resource information of the multimedia resource segments in the different time intervals in the multimedia resource to be played; and

determine, based on the first object interest tag and the multimedia resource information of the multimedia resource segments in the different time intervals, the degrees of interest of the multimedia playing object in the multimedia resource segments in the different time intervals in the multimedia resource to be played.

In some embodiments, the apparatus further includes a determining unit.

The determining unit is configured to: obtain interactive data of the multimedia playing object based on the object identifier;

determine an activity level of the multimedia playing object according to the interactive data; and

in a case that the determining unit determines that the activity level of the multimedia playing object is lower than a first threshold, trigger the obtaining unit 1001 to perform the operation of obtaining a first object interest tag of the multimedia playing object according to the object identifier, and obtaining, according to the multimedia identifier, multimedia resource information of the multimedia resource segments in the different time intervals in the multimedia resource to be played.

In some embodiments, the multimedia resource information includes at least one piece of bullet comment content of the multimedia resource segment, and the obtaining unit 1001 is configured to:

for a multimedia resource segment in any time interval, calculate, according to the first object interest tag and any piece of bullet comment content in the multimedia resource segment, a degree of interest of the multimedia playing object in the any piece of bullet comment content; and

perform weighted summation based on the degree of interest in the any piece of bullet comment content to obtain a degree of interest of the multimedia playing object in the multimedia resource segment.

In some embodiments, the obtaining unit 1001 is configured to:

encode the first object interest tag to obtain a first object interest feature vector, and encode the any piece of bullet comment content in the multimedia resource segment to obtain a bullet comment feature vector of the any piece of bullet comment content;

perform attention interaction on the first object interest feature vector and the bullet comment feature vector of the any piece of bullet comment content to obtain a first fusion feature vector of the any piece of bullet comment content; and

perform interest degree prediction according to the first fusion feature vector of the any piece of bullet comment content to obtain the degree of interest of the multimedia playing object in the any piece of bullet comment content.

In some embodiments, the obtaining unit 1001 is configured to:

obtain a second object interest tag of a publishing object of the any piece of bullet comment content;

encode the second object interest tag to obtain a second object interest feature vector;

perform attention interaction on the first object interest feature vector and the second object interest feature vector to obtain a second fusion feature vector;

perform feature splicing on the first fusion feature vector and the second fusion feature vector to obtain a spliced feature vector; and

perform interest degree prediction according to the spliced feature vector to obtain the degree of interest of the multimedia playing object in the any piece of bullet comment content.

In some embodiments, the apparatus further includes a recording unit.

The recording unit is configured to record bullet comment content whose interest degree reaches a second threshold.

The display unit 1004 is further configured to: in response to movement of a slider of the playback progress bar to a first time interval, preferentially present target bullet comment content on a playing page of the multimedia resource to be played, the target bullet comment content being bullet comment content whose interest degree reaches the second threshold, and the target bullet comment content belonging to at least one piece of bullet comment content of a multimedia resource segment in the first time interval.

In some embodiments, the apparatus further includes a control unit.

The generation unit 1002 is further configured to generate description information of the multimedia resource segments in the different time intervals.

The control unit is configured to: in a process of playing the multimedia resource to be played, in response to a control operation for the slider on the playback progress bar, control the slider to move to a second time interval.

The display unit 1004 is further configured to present the description information of a multimedia resource segment in the second time interval.

In some embodiments, the generation unit 1002 is configured to:

obtain the first object interest tag of the multimedia playing object according to the object identifier, and obtain, according to the multimedia identifier, the multimedia resource information of the multimedia resource segments in the different time intervals in the multimedia resource to be played; and

for a multimedia resource segment in any time interval, generate description information of the multimedia resource segment based on the first object interest tag and multimedia resource information of the multimedia resource segment by using a description prediction model.

In some embodiments, a training manner of the description prediction model includes:

obtaining a first sample object interest tag of a multimedia playing sample object, and obtaining multimedia resource information of a sample multimedia resource;

pre-training, based on the first sample object interest tag and the multimedia resource information, an initial network model with title information of the sample multimedia resource as a training target to obtain a pre-trained model;

obtaining a second sample object interest tag, and obtaining a sample multimedia resource segment from the sample multimedia resource; and

training the pre-trained model based on the second sample object interest tag and multimedia resource information of the sample multimedia resource segment to obtain the description prediction model.

In some embodiments, the multimedia resource information includes at least one of multimedia resource content and bullet comment content.

It can be learned from the foregoing technical solutions that, after a multimedia playing object performs a play operation on a multimedia resource to be played, a playing request can be generated based on the play operation, so that a playing request for the multimedia resource to be played is obtained. The playing request carries an object identifier of the multimedia playing object and a multimedia identifier of the multimedia resource to be played. Therefore, degrees of interest of the multimedia playing object in multimedia resource segments in different time intervals in the multimedia resource to be played can be obtained based on the object identifier and the multimedia identifier. A playback progress bar is generated based on the degrees of interest of the multimedia playing object in the multimedia resource segments in the different time intervals in the multimedia resource to be played, the multimedia resource to be played is played, and the playback progress bar is displayed on a playing page of the multimedia resource to be played during the playing of the multimedia resource to be played. The playback progress bar is used for indicating a playback progress of the multimedia resource to be played and the degrees of interest of the multimedia playing object in the multimedia resource segments in the different time intervals in the multimedia resource to be played. Therefore, the multimedia playing object can learn of the degrees of interest in the multimedia resource segments in the different time intervals based on the playback progress bar, thereby quickly and intuitively finding a location of interest (that is, a time interval). A sliding granularity of the playback progress bar matches a division granularity of the time interval, so that the multimedia playing object can control the playback progress bar to reach the location of interest. In other words, the location of interest may be intuitively found according to the playback progress bar, without repeating a drag operation a plurality of times. In this way, the location of interest can be quickly and accurately located, and the accuracy and efficiency of jumping to the location of interest can be improved, thereby improving user experience.

Some embodiments further provide a computer device. The computer device may be a terminal. As an example, the terminal is a smartphone.

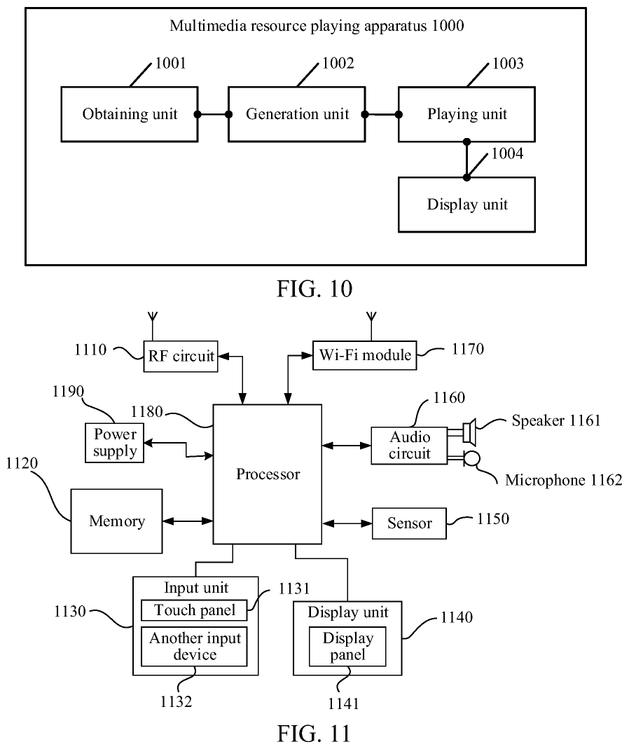

FIG. 11 is a block diagram of a partial structure of the smartphone according to some embodiments. Referring to FIG. 11, the smartphone includes components such as a radio frequency (RF) circuit 1110, a memory 1120, an input unit 1130, a display unit 1140, a sensor 1150, an audio circuit 1160, a wireless fidelity (Wi-Fi) module 1170, a processor 1180, and a power supply 1190. The input unit 1130 may include a touch panel 1131 and another input device 1132. The display unit 1140 may include a display panel 1141. The audio circuit 1160 may include a speaker 1161 and a microphone 1162. A person skilled in the art may understand that a structure of the smartphone shown in FIG. 11 does not constitute a limitation on the smartphone, and the smartphone may include more or fewer components than those shown in the figure, or some components may be combined, or a different component deployment may be used.

The memory 1120 may be configured to store a software program and a module. The processor 1180 runs the software program and the module that are stored in the memory 1120, to perform various function applications and data processing of the smartphone. The memory 1120 may mainly include a program storage area and a data storage area. The program storage area may store an operating system, an application required by at least one function (for example, a sound playing function and an image playing function), or the like. The data storage area may store data (for example, audio data and a phone book) created according to use of the smartphone. In addition, the memory 1120 may include a high speed random access memory, and may also include a non-volatile memory, such as at least one magnetic disk storage device, a flash memory device, or another volatile solid-state storage device.

The processor 1180 is a control center of the smartphone, and is connected to various parts of the entire smartphone by using various interfaces and lines. By running or executing the software program and/or the module stored in the memory 1120, and invoking data stored in the memory 1120, the processor 1180 performs various functions of the smartphone and performs data processing. In some embodiments, the processor 1180 may include one or more processing units. Preferably, the processor 1180 may integrate an application processor and a modem processor. The application processor mainly processes an operating system, a user interface, an application, and the like. The modem processor mainly processes wireless communication. It may be understood that, the modem processor may alternatively not be integrated into the processor 1180.

In this embodiment, the processor 1180 in the smartphone can perform the following operations:

obtaining a playing request for a multimedia resource to be played, the playing request carrying an object identifier of a multimedia playing object and a multimedia identifier of the multimedia resource to be played;

obtaining, based on the object identifier and the multimedia identifier, degrees of interest of the multimedia playing object in multimedia resource segments in different time intervals in the multimedia resource to be played;

generating a playback progress bar based on the degrees of interest of the multimedia playing object in the multimedia resource segments in the different time intervals in the multimedia resource to be played, a sliding granularity of the playback progress bar matching a division granularity of the time interval; and

playing the multimedia resource to be played, and displaying the playback progress bar on a playing page of the multimedia resource to be played during the playing of the multimedia resource to be played, the playback progress bar being used for indicating a playback progress of the multimedia resource to be played and the degrees of interest of the multimedia playing object in the multimedia resource segments in the different time intervals in the multimedia resource to be played.

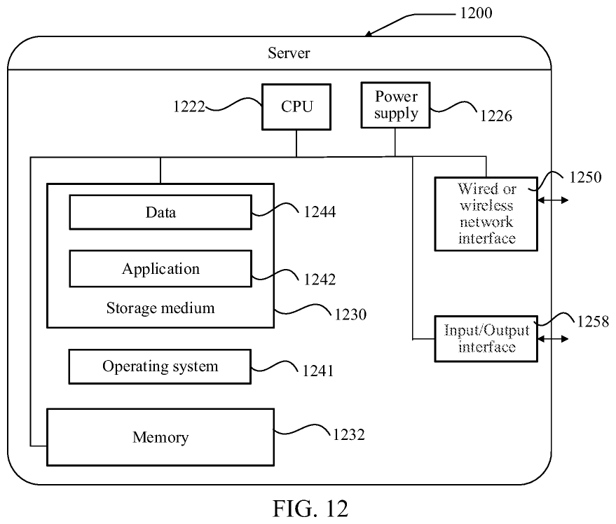

The computer device provided in some embodiments may alternatively be a server. Referring to FIG. 12, FIG. 12 is a structural diagram of a server 1200 according to some embodiments. The server 1200 may differ greatly due to different configurations or performance, and may include one or more processors, such as central processing units (CPUs) 1222, a memory 1232, and one or more storage mediums 1230 (such as one or more mass storage devices) storing an application program 1242 or data 1244. The memory 1232 and the storage medium 1230 may be temporary storage or persistent storage. A program stored in the storage medium 1230 may include one or more modules (not shown), and each module may include a series of instructions and operations for the server. Further, the CPU 1222 may be configured to communicate with the storage medium 1230, and execute a series of instructions and operations in the storage medium 1230 on the server 1200.

The server 1200 May further include one or more power supplies 1226, one or more wired or wireless network interfaces 1250, one or more input/output interfaces 1258, and/or one or more operating systems 1241, such as Windows Server™, Mac OS X™, Unix™, Linux™, or FreeBSD™.

In some embodiments, operations to be performed by the CPU 1222 in the server 1200 can be implemented based on a structure shown in FIG. 12.

According to some embodiments, a computer-readable storage medium is provided, configured to store a computer program, the computer program, when executed by a processor, implementing the multimedia resource playing method described in the foregoing embodiments.

According to some embodiments, a computer program product is provided, including a computer program, the computer program being stored in a computer-readable storage medium. A processor of a computer device reads the computer program from the computer-readable storage medium. The processor executes the computer program, so that the computer device performs the method provided in various optional implementations of the foregoing embodiments.

The descriptions of the procedures or structures corresponding to the accompanying drawings have different emphasis. For parts that are not described in detail in a particular procedure or structure, refer to the relevant descriptions of other procedures or structures.

The terms “first”, “second”, “third”, “fourth”, and so on (if any) herein and the accompanying drawings are intended to distinguish between similar objects and are not necessarily intended to indicate a specific order or sequence. It is to be understood that the data termed in such a way is interchangeable in proper circumstances, so that some embodiments described herein can be implemented, for example, in other orders than the orders illustrated or described herein. Moreover, the terms “include”, “contain”, and any other variants thereof mean to cover the non-exclusive inclusion. For example, a process, method, system, product, or device that includes a list of operations or units is not necessarily limited to those operations or units that are clearly listed, but may include other operations or units not expressly listed or inherent to such a process, method, system, product, or device.

A person skilled in the art would understand that the above “units” could be implemented by hardware logic, a processor or processors executing computer software code, or a combination of both. The “units” may also be implemented in software stored in a memory of a computer or a non-transitory computer-readable medium, where the instructions of each unit are executable by a processor to thereby cause the processor to perform the respective operations of the corresponding unit.

In some embodiments, it is to be understood that the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate components may or may not be physically separated, and the components displayed as units may or may not be physical units, and may be located in one place or may be distributed on a plurality of network units. Some or all of the units may be selected according to actual needs to achieve the objectives of the solutions of the embodiments.

In addition, functional units in some embodiments may be integrated into one processing unit, or each of the units may exist alone physically, or two or more units may be integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions essentially, or a part contributing to the related art, or all or a part of the technical solutions may be implemented in a form of a software product. The computer software product is stored in a storage medium and includes a plurality of instructions for instructing a computer device to perform all or some of the operations of the methods in some embodiments. The foregoing storage medium includes various mediums capable of storing computer programs, such as a USB flash drive, a removable hard disk, a read-only memory (ROM), a random access memory (RAM), a magnetic disk, or an optical disc.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A multimedia resource playing method, performed by a computer device, comprising:
obtaining a playing request for a multimedia resource to be played, the playing request carrying an object identifier of a multimedia playing object and a multimedia identifier of the multimedia resource to be played;
obtaining, based on the object identifier and the multimedia identifier, degrees of interest of the multimedia playing object in multimedia resource segments in different time intervals in the multimedia resource to be played;
generating a playback progress bar based on the degrees of interest of the multimedia playing object, a sliding granularity of the playback progress bar matching a division granularity of each time interval; and
playing the multimedia resource to be played, and displaying the playback progress bar on a playing page of the multimedia resource to be played during the playing of the multimedia resource to be played, the playback progress bar indicating a playback progress of the multimedia resource to be played and the degrees of interest of the multimedia playing object.

2. The multimedia resource playing method according to claim 1, wherein obtaining the degrees of interest of the multimedia playing object comprises:
searching, according to the object identifier and the multimedia identifier, an interest degree storage space for the degrees of interest of the multimedia playing object, the interest degree storage space storing degrees of respective interest of a plurality of objects in multimedia resource segments in different time intervals in different multimedia resources, and the plurality of objects comprising the multimedia playing object.

3. The multimedia resource playing method according to claim 2, further comprising:
obtaining interactive data of the multimedia playing object based on the object identifier;
determining an activity level of the multimedia playing object according to the interactive data; and
based on the activity level of the multimedia playing object being higher than a first threshold, searching, according to the object identifier and the multimedia identifier, the interest degree storage space for the degrees of interest of the multimedia playing object in the multimedia resource segments in the different time intervals in the multimedia resource to be played.

4. The multimedia resource playing method according to claim 1, wherein obtaining, based on the object identifier and the multimedia identifier, the degrees of interest of the multimedia playing object comprises:
obtaining a first object interest tag of the multimedia playing object according to the object identifier, and obtaining, according to the multimedia identifier, multimedia resource information of the multimedia resource segments in the different time intervals in the multimedia resource to be played; and
determining, based on the first object interest tag and the multimedia resource information of the multimedia resource segments in the different time intervals, the degrees of interest of the multimedia playing object in the multimedia resource segments in the different time intervals in the multimedia resource to be played.

5. The multimedia resource playing method according to claim 4, further comprising:
obtaining interactive data of the multimedia playing object based on the object identifier;
determining an activity level of the multimedia playing object according to the interactive data; and
based on the activity level of the multimedia playing object being lower than a first threshold, obtaining the first object interest tag of the multimedia playing object according to the object identifier, and obtaining, according to the multimedia identifier, the multimedia resource information of the multimedia resource segments in the different time intervals in the multimedia resource to be played.

6. The multimedia resource playing method according to claim 4, wherein the multimedia resource information comprises at least one piece of bullet comment content of the multimedia resource segment, and
wherein determining, based on the first object interest tag and the multimedia resource information of the multimedia resource segments in the different time intervals, the degrees of interest of the multimedia playing object comprises:
for a multimedia resource segment in any time interval, calculating, according to the first object interest tag and any piece of bullet comment content in the multimedia resource segment, a degree of interest of the multimedia playing object in the any piece of bullet comment content; and
performing weighted summation based on the degree of interest in the any piece of bullet comment content to obtain a degree of interest of the multimedia playing object in the multimedia resource segment.

7. The multimedia resource playing method according to claim 6, wherein calculating, according to the first object interest tag and the any piece of bullet comment content in the multimedia resource segment, the degree of interest of the multimedia playing object in the any piece of bullet comment content comprises:
encoding the first object interest tag to obtain a first object interest feature vector, and encoding the any piece of bullet comment content in the multimedia resource segment to obtain a bullet comment feature vector of the any piece of bullet comment content;
performing attention interaction on the first object interest feature vector and the bullet comment feature vector of the any piece of bullet comment content to obtain a first fusion feature vector of the any piece of bullet comment content; and
performing interest degree prediction according to the first fusion feature vector of the any piece of bullet comment content to obtain the degree of interest of the multimedia playing object in the any piece of bullet comment content.

8. The multimedia resource playing method according to claim 7, wherein performing the interest degree prediction according to the first fusion feature vector of the any piece of bullet comment content comprises:
obtaining a second object interest tag of a publishing object of the any piece of bullet comment content;
encoding the second object interest tag to obtain a second object interest feature vector;
performing attention interaction on the first object interest feature vector and the second object interest feature vector to obtain a second fusion feature vector;
performing feature splicing on the first fusion feature vector and the second fusion feature vector to obtain a spliced feature vector; and
performing interest degree prediction according to the spliced feature vector to obtain the degree of interest of the multimedia playing object in the any piece of bullet comment content.

9. The multimedia resource playing method according to claim 6, further comprising:
recording bullet comment content whose interest degree reaches a second threshold; and
based on movement of a slider of the playback progress bar to a first time interval presenting target bullet comment content on the playing page of the multimedia resource to be played, the target bullet comment content being bullet comment content whose interest degree reaches the second threshold, and the target bullet comment content belonging to at least one piece of bullet comment content of a multimedia resource segment in the first time interval.

10. The multimedia resource playing method according to claim 1, further comprising:
generating description information of the multimedia resource segments in the different time intervals; and
in a process of playing the multimedia resource to be played, based on a control operation for the slider on the playback progress bar, controlling the slider to move to a second time interval, and presenting the description information of the multimedia resource segment in the second time interval.

11. The multimedia resource playing method according to claim 10, wherein generating the description information of the multimedia resource segments in the different time intervals comprises:
obtaining the first object interest tag of the multimedia playing object according to the object identifier, and obtaining, according to the multimedia identifier, the multimedia resource information of the multimedia resource segments in the different time intervals in the multimedia resource to be played; and
for a multimedia resource segment in any time interval, generating the description information of the multimedia resource segment based on the first object interest tag and multimedia resource information of the multimedia resource segment with a description prediction model.

12. The multimedia resource playing method according to claim 11, wherein a training manner of the description prediction model comprises:
obtaining a first sample object interest tag of a multimedia playing sample object, and obtaining multimedia resource information of a sample multimedia resource;
pre-training, based on the first sample object interest tag and the multimedia resource information, an initial network model with title information of the sample multimedia resource as a training target to obtain a pre-trained model;
obtaining a second sample object interest tag, and obtaining a sample multimedia resource segment from the sample multimedia resource; and
training the pre-trained model based on the second sample object interest tag and the multimedia resource information of the sample multimedia resource segment to obtain the description prediction model.

13. The multimedia resource playing method according to claim 11, wherein the multimedia resource information comprises at least one of multimedia resource content and bullet comment content.

14. A multimedia resource playing apparatus:
at least one memory configured to store program code; and
at least one processor configured to read the program code and operate as instructed by the program code, the program code comprising:
obtaining code configured to cause at least one of the at least one processor to:
obtain a playing request for a multimedia resource to be played, the playing request carrying an object identifier of a multimedia playing object and a multimedia identifier of the multimedia resource to be played, and
obtain, based on the object identifier and the multimedia identifier, degrees of interest of the multimedia playing object in multimedia resource segments in different time intervals in the multimedia resource to be played;
generation code configured to cause at least one of the at least one processor to generate a playback progress bar based on the degrees of interest of the multimedia playing object, a sliding granularity of the playback progress bar matching a division granularity of each time interval;
playing code configured to cause at least one of the at least one processor to play the multimedia resource to be played; and
display code configured to cause at least one of the at least one processor to display the playback progress bar on a playing page of the multimedia resource to be played during the playing of the multimedia resource to be played, the playback progress bar being used for indicating a playback progress of the multimedia resource to be played and the degrees of interest of the multimedia playing object.

15. The multimedia resource playing apparatus according to claim 14, wherein the obtaining code is further configured to cause at least one of the at least one processor to:
search, according to the object identifier and the multimedia identifier, an interest degree storage space for the degrees of interest of the multimedia playing object, the interest degree storage space storing degrees of respective interest of a plurality of objects in multimedia resource segments in different time intervals in different multimedia resources, and the plurality of objects comprising the multimedia playing object.

16. The multimedia resource playing apparatus according to claim 15, wherein the program code further comprises determining code configured to cause at least one of the at least one processor to:
obtain interactive data of the multimedia playing object based on the object identifier;
determine an activity level of the multimedia playing object according to the interactive data; and
based on the activity level of the multimedia playing object being higher than a first threshold, search, according to the object identifier and the multimedia identifier, the interest degree storage space for the degrees of interest of the multimedia playing object in the multimedia resource segments in the different time intervals in the multimedia resource to be played.

17. The multimedia resource playing apparatus according to claim 14, wherein the obtaining code is further configured to cause at least one of the at least one processor to:
obtain a first object interest tag of the multimedia playing object according to the object identifier, and obtaining, according to the multimedia identifier, multimedia resource information of the multimedia resource segments in the different time intervals in the multimedia resource to be played; and
determine, based on the first object interest tag and the multimedia resource information of the multimedia resource segments in the different time intervals, the degrees of interest of the multimedia playing object in the multimedia resource segments in the different time intervals in the multimedia resource to be played.

18. The multimedia resource playing apparatus according to claim 17, wherein the determining code is further configured to cause at least one of the at least one processor to:
obtain interactive data of the multimedia playing object based on the object identifier;
determine an activity level of the multimedia playing object according to the interactive data; and
based on the activity level of the multimedia playing object being lower than a first threshold, obtain the first object interest tag of the multimedia playing object according to the object identifier, and obtain, according to the multimedia identifier, the multimedia resource information of the multimedia resource segments in the different time intervals in the multimedia resource to be played.

19. The multimedia resource playing apparatus according to claim 17, wherein the multimedia resource information comprises at least one piece of bullet comment content of the multimedia resource segment, and
wherein the obtaining code is further configured to cause at least one of the at least one processor to:
for a multimedia resource segment in any time interval, calculate, according to the first object interest tag and any piece of bullet comment content in the multimedia resource segment, a degree of interest of the multimedia playing object in the any piece of bullet comment content; and
perform weighted summation based on the degree of interest in the any piece of bullet comment content to obtain a degree of interest of the multimedia playing object in the multimedia resource segment.

20. A non-transitory computer-readable storage medium storing computer code which, when executed by at least one processor, causes the at least one processor to at least:
obtain a playing request for a multimedia resource to be played, the playing request carrying an object identifier of a multimedia playing object and a multimedia identifier of the multimedia resource to be played;
obtain, based on the object identifier and the multimedia identifier, degrees of interest of the multimedia playing object in multimedia resource segments in different time intervals in the multimedia resource to be played;
generate a playback progress bar based on the degrees of interest of the multimedia playing object, a sliding granularity of the playback progress bar matching a division granularity of each time interval; and
play the multimedia resource to be played, and display the playback progress bar on a playing page of the multimedia resource to be played during the playing of the multimedia resource to be played, the playback progress bar indicating a playback progress of the multimedia resource to be played and the degrees of interest of the multimedia playing object.
